(19) United States
(12) Patent Application Publication
(10) Pub. No.: US 2026/0222995 A1
(43) Pub. Date: Jul. 30, 2026

(54) METHODS TO OPERATE WUR WITHOUT SLEEPING

(71) Applicant: Telefonaktiebolaget LM Ericsson (publ), Stockholm (SE)

(72) Inventors: Chunhui Zhang, Stockholm (SE); Mohammad Mozaffari, Fremont, CA (US); Yanpeng Yang, Järfäälla (SE); Andreas Höglund, Solna (SE); Muhammad Kazmi, Sundbyberg (SE); Zhilan Xiong, Solna (SE); Thomas Chapman, Solna (SE); Santhan Thangarasa, Vällingby (SE)

(21) Appl. No.: 19/145,401

(22) PCT Filed: Jan. 30, 2024
(86) PCT No.: PCT/SE2024/050077

§ 371 Date: Jul. 2, 2025

Related U.S. Application Data
(60) Provisional application No. 63/482,088, filed on Jan. 30, 2023.

(51) Int. Cl. H04W 52/02; H04B 17/318; H04L 5/00; H04W 8/22; H04W 24/10

(52) U.S. Cl. CPC H04W 52/0235; H04B 17/328; H04L 5/0051; H04W 8/22; H04W 24/10

(57) ABSTRACT

Systems and methods are disclosed for enabling proper functioning of a Wake-Up Receiver (WUR) of a User Equipment (UE). In one embodiment, a method performed by a UE equipped with a main receiver and one or more WURs comprises sending, to a network node, information about the WURs. For each WUR, the information indicates: (a) whether the radio frequency (RF) or intermediate frequency (IF) performance, selectivity, intermodulation rejection performance, and/or sensitivity of the WUR is reduced or the same as that of the main receiver; information about an architecture of the WUR; a WUR type of the WUR; one or more parameters of the WUR; information about one or more RF/IF capabilities of the WUR; or any combination of two or more thereof.

### RELATED APPLICATIONS

This application claims the benefit of provisional patent application Ser. No. 63/482,088, filed Jan. 30, 2023, the disclosure of which is hereby incorporated herein by reference in its entirety.

### TECHNICAL FIELD

The present disclosure relates to a wireless communication system and, more specifically, to wake-up signaling in a wireless communication system.

### BACKGROUND

### Wake-Up Signal and Wake-Up Radio

Wake-Up Receiver (WUR), sometimes also referred to as ‘wake-up radio’, is about enabling a low power receiver in a User Equipment (UE), which, in case of the detection of a Wake-Up Signal (WUS), wakes up the main (baseband/radio frequency (RF)/less power efficient) receiver to detect an incoming message, typically a paging message (e.g. a Physical Downlink Control Channel (PDCCH) in a paging occasion (PO) scheduling the paging message on a Physical Downlink Shared Channel (PDSCH)). The main benefit of employing WUR is lower energy consumption and longer device battery life, or, at a fixed energy consumption, the downlink latency can be reduced (e.g., shorter Discontinuous Reception (DRX)/duty-cycles and more frequent checks for incoming transmissions).

In general, two approaches for detecting WUS are as follows:
Detecting WUS using the main receiver:
   No need for additional dedicated hardware/receiver for monitoring WUS
   Coverage of the main receiver is not typically impacted
   Limited power saving gain as the main receiver monitors WUS
Detecting WUS using a dedicated receiver (i.e., a WUR):
   Extremely low power, simple and low-cost receiver architecture, relaxed requirements, noisier (i.e., less accurate) clock or oscillator
   Significant power saving gain can be achieved by maximizing the time in which the main receiver can be in the sleep mode
   Enablers for zero energy/battery-less devices, and energy harvesting operations.
   There are coverage considerations given the tradeoff between WUR power consumption and sensitivity.

FIG. 1 shows an example of a UE including both a main receiver and a dedicated WUR. The WUR is used for monitoring for a WUS. Once the WUR detects the intended WUS, the WUR wakes up the main (baseband/RF/less power efficient) receiver to detect further incoming messages. Therefore, the main receiver can go to sleep mode and save power until it is triggered by the WUR.

### Rel-18 NR WUR

In Release 18 of the 3^{rd} Generation Partnership Project (3GPP) specifications, there has been rather large interest in introducing WUR for New Radio (NR), with a goal of achieving more significant energy efficiency improvement compared to solutions already specified in earlier releases. The only specification support needed to be able to use a WUR in the UE is the specification of a WUS and a long enough time gap between the WUS and the PDCCH in the PO to allow the UE to start up the main receiver. Therefore, the main difference to Release 17 Paging Early Indication (PEI) is the WUS in Release 18 should not be PDCCH-based and allow for a simpler and lower power receiver, i.e. WUR with simple modulation and detection techniques (e.g., using on-off keying (OOK) modulation and non-coherent detection, or Frequency Shift Keying (FSK)).

In Release 18, a study item on “low-power wake-up signal and receiver for NR” was approved (see RP-213645). The relevant justification and objective sections stated in RP-213645 are included in the following excerpt from RP-213645.

### START EXCERPT FROM RP-213645

### Justification

5G systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in RRC idle/inactive state and hundreds of milliwatts in RRC connected state. Designs to prolong battery life is a necessity for improving energy efficiency as well as for better user experience.

Energy efficiency is even more critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least few years as described in TR 38.875. Wearables include smart watches, rings, eHealth related devices, and medical monitoring devices. With typical battery capacity, it is challenging to sustain up to 1-2 weeks as required.

The power consumption depends on the configured length of wake-up periods, e.g., paging cycle. To meet the battery life requirements above, eDRX cycle with large value is expected to be used, resulting in high latency, which is not suitable for such services with requirements of both long battery life and low latency. For example, in fire detection and extinguishment use case, fire shutters shall be closed and fire sprinklers shall be turned on by the actuators within 1 to 2 seconds from the time the fire is detected by sensors, long eDRX cycle cannot meet the delay requirements. eDRX is apparently not suitable for latency-critical use cases. Thus, the intention is to study ultra-low power mechanism that can support low latency in Rel-18, e.g. lower than eDRX latency.

Currently, UEs need to periodically wake up once per DRX cycle, which dominates the power consumption in periods with no signalling or data traffic. If UEs are able to wake up only when they are triggered, e.g., paging, power consumption could be dramatically reduced. This can be achieved by using a wake-up signal to trigger the main radio and a separate receiver which has the ability to monitor wake-up signal with ultra-low power consumption. Main radio works for data transmission and reception, which can be turned off or set to deep sleep unless it is turned on.

The power consumption for monitoring wake-up signal depends on the wake-up signal design and the hardware module of the wake-up receiver used for signal detecting and processing.

The study should primarily target low-power WUS/WUR for power-sensitive, small form-factor devices including IoT use cases (such as industrial sensors, controllers) and wearables. Other use cases are not precluded, e.g.XR/smart glasses, smart phones.

### Objective of SI

As opposed to the work on UE power savings in previous releases, this study will not require existing signals to be used as WUS. All WUS solutions identified shall be able to operate in a cell supporting legacy UEs. Solutions should target substantial gains compared to the existing Rel-15/16/17 UE power saving mechanisms. Other aspects such as detection performance, coverage, UE complexity, should be covered by the evaluation.

The study item includes the following objectives:
Identify evaluation methodology (including the use cases) & KPIs [RAN1]
   Primarily target low-power WUS/WUR for power-sensitive, small form-factor devices including IoT use cases (such as industrial sensors, controllers) and wearables
      Other use cases are not precluded
Study and evaluate low-power wake-up receiver architectures [RAN1, RAN4]
Study and evaluate wake-up signal designs to support wake-up receivers [RAN1, RAN4]
Study and evaluate L1 procedures and higher layer protocol changes needed to support the wake-up signals [RAN2, RAN1]
Study potential UE power saving gains compared to the existing Rel-15/16/17 UE power saving mechanisms and their coverage availability, as well as latency impact. System impact, such as network power consumption, coexistence with non-low-power-WUR UEs, network coverage/capacity/resource overhead should be included in the study [RAN1]
   Note: The need for RAN2 evaluation will be triggered by RAN1 when necessary.

### END EXCERPT FROM RP-213645

The benefit of WUR is to reduce the energy consumption of the receiver such that, unless there is any paging and data for the UE, the UE can remain in a power saving state. This will extend the battery life of the UE, or alternatively enable shorter downlink latency (shorter DRX) at a fixed battery life. For short-range communication, the WUR power can be low enough (~10 microwatts (μW)) that this can even, in combination with energy harvesting, enable the WUR to be continuously on (i.e., DRX or duty-cycling is not used) without the need for a battery. This can be considered as a key enabler of battery-less devices towards 6th Generation (6G).

Within the Release 18 study, different WUR architectures are under study. Some examples are shown in FIGS. 2A-2C. In particular, FIG. 2A shows an example architecture with RF envelope detection. FIG. 2B shows an example heterodyne architecture with Intermediate Frequency (IF) envelope detection. FIG. 2C shows an example homodyne/zero-IF architecture with baseband envelope detection.

### Power and Sensitivity Tradeoff

The design challenge in receivers for Internet of Things (IoT) applications is to minimize the power consumption with an adequate sensitivity level. In WUR design, receiver sensitivity is an important parameter as it provides the lowest power level at which the receiver can detect a WUS. Generally, high sensitivity requires more power consuming electronics (e.g. Low-Noise Amplifier (LNA)) at the receiver side, thus high-power demand. In contrast, low sensitivity for the same communication range will require high radiated power at the transmitter side. Because of this, sensitivity requirements often lead to over-design to ensure reliable communication in adverse conditions. When the WUR is used to trigger a less energy-efficient and more power consuming main receiver, ideally the WUR and the main receiver should have the same range.

As an example, the tradeoff between sensitivity/coverage and energy consumption of WUR is shown in FIG. 3 based on the existing low-power radio designs. As can be seen from FIG. 3, for every 20 decibels (dB) of improvement in sensitivity, there is at least a 10× increase in power consumption. Note that FIG. 3 is a survey on power vs. sensitivity for low power radios (reference: David D. Wentzloff et al., “Ultralow-Power Receivers: Overcoming Battery Limitations to Facilitate Self-Powered Operation,” IEEE Solid-State Circuits Magazine, Vol. 13, Issue 3, Summer 2021 Aug. 26, 2021, pp. 33-37).

### SUMMARY

Systems and methods are disclosed for enabling proper functioning of a Wake-Up Receiver (WUR) of a User Equipment (UE) in a wireless communication system. In one embodiment, a method performed by a UE equipped with a main receiver and WURs comprises sending, to a network node, information about the one or more WURs of the UE. For each WUR of the one or more WURs, the information indicates: (a) whether the radio frequency or intermediate frequency performance of the WUR is reduced as compared to or the same as that of the main receiver; (b) whether a selectivity of the WUR is reduced as compared to or the same as that of the main receiver; (c) whether an intermodulation rejection performance of the WUR is reduced as compared to or the same as that of the main receiver; (d) whether a sensitivity of the WUR is reduced as compared to or the same as that of the main receiver; (e) information about an architecture of the WUR; (f) a WUR type of the WUR; (g) one or more parameters of the WUR; (h) information about one or more radio frequency capabilities of the WUR and/or information about one or more intermediate frequency capabilities of the WUR; or (i) any combination of two or more of (a)-(h). In this manner, the network can use this information in order to ensure reachability of the UE.

In one embodiment, for each WUR of the one or more WURs, the information indicates a WUR type of the WUR. In one embodiment, for each WUR of the one or more WURs, the WUR type of the WUR is one of two or more defined WUR types each associated to one or more different sets of WUR related parameters, the WUR related parameters comprising; (i) radio frequency or intermediate frequency performance, (ii) selectivity, (iii) intermodulation rejection performance, (iv) sensitivity, or any combination of two or more of (i)-(iv).

In one embodiment, the information comprises, for each WUR of the one or more WURs, information that indicates one or more parameters of the WUR. In one embodiment, the one or more parameters of the WUR comprise a noise figure of the WUR, one or more filtering parameters of one or more filters of the WUR, and/or one or more clock impairments of the WUR.

In one embodiment, the information comprises, for each WUR of the one or more WURs, information about an architecture of the WUR. In one embodiment, the information about the architecture of the WUR is in terms of low-noise amplifier(s), analog-to-digital conversion, supported modulation scheme(s), and/or number of antennas.

In one embodiment, the information comprises, for each WUR of the one or more WURs, information about one or more radio frequency capabilities of the WUR and/or information about one or more intermediate frequency capabilities of the WUR.

In one embodiment, the one or more WURs comprise two or more WURs.

In one embodiment, the method further comprises monitoring a serving cell signal level via a WUR, from among the one or more WURs, having reduced radio frequency and/or intermediate performance in terms of sensitivity, selectivity, and/or intermodulation rejection performance compared to that of the main receiver and determining that the serving cell signal level is less than a predefined or configured threshold signal level. The method further comprises, responsive to determining that the serving cell signal level is less than a predefined or configured threshold signal level, disabling the WUR. In one embodiment, the method further comprises, responsive to determining that the serving cell signal level is less than a predefined or configured threshold signal level, sending a message or indication to the network node that indicates that the WUR is out-of-coverage and therefore that the main receiver of the UE is used.

In one embodiment, the method further comprises detecting a strength and/or quality of one or more signals via a WUR, from among the one or more WURs, determining that the strength and/or quality of the one or more signals satisfy one or more requirements for triggering transmission of WUS to the UE, and sending information or an indication to the network node that triggers enabling transmission of WUS to the UE.

In one embodiment, the method further comprises monitoring a blocker or interferer signal level and/or a received power of one or more reference signals of the serving cell, using a WUR, from among the one or more WURs and determining whether to use the main receiver of the UE based on one or more results of the monitoring. In one embodiment, determining whether to use the main receiver of the UE comprises determining to use the main receiver, and the method further comprises waking up the main receiver and disabling the WUR. In one embodiment, the method further comprises sending a message or indication to the network node that indicates that the WUR is out of coverage and that the main receiver is used by the UE.

In one embodiment, the one or more WURs comprise two or more WURs, and the method further comprises switching between the two or more WURs in accordance with one or more rules.

In one embodiment, the one or more WURs comprise two or more WURs, and the method further comprises periodically switching between the two or more WURs.

In one embodiment, the method further comprises measuring a reference signal received power (RSRP) value for a signal using a WUR from among the one or more WURs, applying an offset to the RSRP value to provide an adjusted RSRP value, and determining whether to activate the WUR and WUS transmission to the UE based on a comparison of the adjusted RSRP value and a threshold RSRP value.

In one embodiment, the method further comprises measuring a RSRP value for a signal using a WUR from among the one or more WURs, applying an offset to a threshold RSRP value to provide an adjusted threshold RSRP value, and determining whether to the activate the WUR and WUS transmission to the UE based on a comparison of the RSRP value and the adjusted threshold RSRP value.

In one embodiment, the offset compensates for difference in sensitivity between the WUR and the main receiver of the UE.

In one embodiment, the method further comprises performing one or more actions using the one or more WURs. In one embodiment, the one or more actions using the one or more WURs comprise measuring a signal strength or quality of one or more signals using a WUR and determining whether to activate or deactivate the WUR based on the measured signal strength or quality of the one or more signals. In one embodiment, the one or more actions further comprise, responsive to determining to activate the WUR, sending a message or indication to the network node to trigger activation of transmission of wake-up signals to the UE. In another embodiment, the one or more actions further comprise, responsive to determining to deactivate the WUR, deactivating the WUR with respect to monitoring for a WUS. In another embodiment, the one or more actions further comprise, responsive to determining to deactivate the WUR, sending a message or indication to the network node that indicates that the WUR has been deactivated and/or that the UE is using the main receiver rather than the WUR.

In one embodiment, the one or more WURs comprise two or more WURs, and the one or more actions comprise switching between the two or more WURs in accordance with one or more rules.

In one embodiment, the one or more WURs comprise two or more WURs, and the one or more actions comprise periodically switching between the two or more WURs.

In one embodiment, the one or more actions using the one or more WURs comprise measuring a RSRP value for a signal using a WUR, applying an offset to the RSRP value to provide an adjusted RSRP value, and determining whether to activate the WUR (e.g., and WUS transmission) based on a comparison of the adjusted RSRP value and a threshold RSRP value.

In one embodiment, the one or more actions using the one or more WURs comprise measuring a RSRP value for a signal using a WUR, applying an offset to a threshold RSRP value to provide an adjusted threshold RSRP value, and determining whether to the activate the WUR (e.g., and WUS transmission) based on a comparison of the RSRP value and the adjusted threshold RSRP value.

In one embodiment, the offset compensates for difference in sensitivity between the WUR and the main receiver of the UE.

Corresponding embodiment of a UE are also disclosed. In one embodiment, a UE equipped with a main receiver and one or more WURs is adapted to send, to a network node, information about the one or more WURs of the UE. For each WUR of the one or more WURs, the information indicates: (a) whether the radio frequency or intermediate frequency performance of the WUR is reduced as compared to or the same as that of the main receiver; (b) whether a selectivity of the WUR is reduced as compared to or the same as that of the main receiver; (c) whether an intermodulation rejection performance of the WUR is reduced as compared to or the same as that of the main receiver; (d) whether a sensitivity of the WUR is reduced as compared to or the same as that of the main receiver; (e) information about an architecture of the WUR; (f) a WUR type of the WUR; (g) one or more parameters of the WUR; (h) information about one or more radio frequency capabilities of the WUR and/or information about one or more intermediate frequency capabilities of the WUR; or (i) any combination of two or more of (a)-(h).

In one embodiment, a UE comprises a main receiver, one or more WURs, and processing circuitry associated with the main receiver and the one or more WURs. The processing circuitry is configured to cause the UE to send, to a network node, information about the one or more WURs of the UE. For each WUR of the one or more WURs, the information indicates: (a) whether the radio frequency or intermediate frequency performance of the WUR is reduced as compared to or the same as that of the main receiver; (b) whether a selectivity of the WUR is reduced as compared to or the same as that of the main receiver; (c) whether an intermodulation rejection performance of the WUR is reduced as compared to or the same as that of the main receiver; (d) whether a sensitivity of the WUR is reduced as compared to or the same as that of the main receiver; (e) information about an architecture of the WUR; (f) a WUR type of the WUR; (g) one or more parameters of the WUR; (h) information about one or more radio frequency capabilities of the WUR and/or information about one or more intermediate frequency capabilities of the WUR; or (i) any combination of two or more of (a)-(h).

In another embodiment, a method performed by a UE equipped with a main receiver and one or more WUR comprises monitoring one or more parameters via a WUR, from among the one or more WURs, having reduced radio frequency or intermediate frequency performance as compared to the main receiver of the UE, the one or more parameters comprising (a) a serving cell signal level, (b) a strength and/or quality of one or more specific signals, (c) a blocker or interferer signal level; or (d) a reference signal received power, RSRP, of one or more reference signals of the serving cell. The method further comprises determining whether to use the WUR or the main receiver of the UE, based on the one or more parameters and using either the WUR or the main receiver of the UE, in accordance with a result of the determining whether to use the WUR or the main receiver of the UE.

In one embodiment, the one or more parameters comprise the serving cell signal level, determining whether to use the WUR or the main receiver of the UE comprises determining that the serving cell signal level is less than a threshold signal level, and either using the WUR or the main receiver comprises disabling the WUR such that the UE uses the main receiver rather than the WUR. In one embodiment, the method further comprises sending, to a network node, a message or indication that indicates that the WUR is out-of-coverage and therefore that the main receiver is used.

In one embodiment, the one or more parameters comprise the strength and/or quality of one or more specific signals, determining whether to use the WUR or the main receiver of the UE comprises determining that the strength and/or quality of the one or more specific signals satisfy one or more requirements for use of the WUR to monitor for a Wake-Up Signal (WUS), and either using the WUR or the main receiver comprises using the WUR to monitor for a WUS. In one embodiment, the method further comprises sending, to a network node, information or an indication that triggers enabling transmission of WUS to the UE.

In one embodiment, the one or more parameters comprise a blocker or interferer signal level and/or a RSRP of one or more reference signals of the serving cell, determining whether to use the WUR or the main receiver of the UE comprises determining to use the main receiver rather the WUR, based on the blocker or interferer signal level and/or the RSRP of one or more reference signals of the serving cell, and either using the WUR or the main receiver comprises using the WUR to monitor for a WUS. In one embodiment, the method further comprises sending, to a network node, message or indication that the WUR is out-of-coverage and that the main receiver rather than the WUR is used.

Corresponding embodiments of a UE are also disclosed. In one embodiment, a UE equipped with a main receiver and one or more WUR is adapted to monitor one or more parameters via a WUR, from among the one or more WURs, having reduced radio frequency or intermediate frequency performance as compared to the main receiver of the UE, the one or more parameters comprising (a) a serving cell signal level, (b) a strength and/or quality of one or more specific signals, (c) a blocker or interferer signal level; or (d) a reference signal received power, RSRP, of one or more reference signals of the serving cell. The UE is further adapted to determine whether to use the WUR or the main receiver of the UE, based on the one or more parameters and use either the WUR or the main receiver of the UE, in accordance with a result of the determining whether to use the WUR or the main receiver of the UE.

In another embodiment, a UE comprises a main receiver, one or more WUR, and processing circuitry associated with the main receiver and the one or more WURs. The processing circuitry is configured to cause the UE to monitor one or more parameters via a WUR, from among the one or more WURs, having reduced radio frequency or intermediate frequency performance as compared to the main receiver of the UE, the one or more parameters comprising (a) a serving cell signal level, (b) a strength and/or quality of one or more specific signals, (c) a blocker or interferer signal level; or (d) a reference signal received power, RSRP, of one or more reference signals of the serving cell. The processing circuitry is further configured to cause the UE to determine whether to use the WUR or the main receiver of the UE, based on the one or more parameters and use either the WUR or the main receiver of the UE, in accordance with a result of the determining whether to use the WUR or the main receiver of the UE.

Embodiments of a method performed by a network node are also disclosed. In one embodiment, a method performed by a network node comprises receiving, from a UE, information about one or more WUR of the UE. For each WUR of the one or more WURs, the information indicates: (a) whether the radio frequency or intermediate frequency performance of the WUR is reduced as compared to or the same as that of the main receiver; (b) whether a selectivity of the WUR is reduced as compared to or the same as that of the main receiver; (c) whether an intermodulation rejection performance of the WUR is reduced as compared to or the same as that of the main receiver; (d) whether a sensitivity of the WUR is reduced as compared to or the same as that of the main receiver; (e) information about an architecture of the WUR; (f) a WUR type of the WUR; (g) one or more parameters of the WUR; (h) information about one or more radio frequency capabilities of the WUR and/or information about one or more intermediate frequency capabilities of the WUR; or (i) any combination of two or more of (a)-(h).

In one embodiment, the method further comprises performing one or more actions based on the information about the one or more WURs of the UE. In one embodiment, the one or more actions comprise activating transmission of wake-up signals to the UE. In one embodiment, the one or more actions comprise storing at least some of the information about the WURs in a UE context of the UE. In one embodiment, the one or more actions further comprise sending the information about the WURs of the UE to another network node. In one embodiment, the one or more actions comprise adapting resources and/or coding used for WUS transmission to the UE based on the information about the WURs of the UE.

Corresponding embodiments of a network node are also disclosed. In one embodiment, a network node is adapted to receive, from a UE, information about one or more WUR of the UE. For each WUR of the one or more WURs, the information indicates: (a) whether the radio frequency or intermediate frequency performance of the WUR is reduced as compared to or the same as that of the main receiver; (b) whether a selectivity of the WUR is reduced as compared to or the same as that of the main receiver; (c) whether an intermodulation rejection performance of the WUR is reduced as compared to or the same as that of the main receiver; (d) whether a sensitivity of the WUR is reduced as compared to or the same as that of the main receiver; (e) information about an architecture of the WUR; (f) a WUR type of the WUR; (g) one or more parameters of the WUR; (h) information about one or more radio frequency capabilities of the WUR and/or information about one or more intermediate frequency capabilities of the WUR; or (i) any combination of two or more of (a)-(h).

In one embodiment, a network node comprises processing circuitry configured to cause the network node to receive, from a UE, information about one or more WUR of the UE. For each WUR of the one or more WURs, the information indicates: (a) whether the radio frequency or intermediate frequency performance of the WUR is reduced as compared to or the same as that of the main receiver; (b) whether a selectivity of the WUR is reduced as compared to or the same as that of the main receiver; (c) whether an intermodulation rejection performance of the WUR is reduced as compared to or the same as that of the main receiver; (d) whether a sensitivity of the WUR is reduced as compared to or the same as that of the main receiver; (e) information about an architecture of the WUR; (f) a WUR type of the WUR; (g) one or more parameters of the WUR; (h) information about one or more radio frequency capabilities of the WUR and/or information about one or more intermediate frequency capabilities of the WUR; or (i) any combination of two or more of (a)-(h).

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example of a User Equipment (UE) including both a main receiver and a dedicated Wake-Up Receiver (WUR);

FIGS. 2A-2C illustrate different WUR architectures studied within the 3rd Generation Partnership Project (3GPP) Release 18 Study on low-power wake-up signal and receiver for New Radio (NR);

FIG. 3 illustrates the tradeoff between sensitivity/coverage and energy consumption of WUR;

FIG. 4 illustrates a UE including a Main Receiver (MR) and one or more WURs, in accordance with an embodiment of the present disclosure;

FIG. 5A illustrates the operation of a UE and a network node 500 in accordance with embodiments of the present disclosure;

FIG. 5B illustrates an example embodiment of actions performed by a UE using a WUR(s);

FIG. 5C illustrates an example embodiment of actions performed by a UE to trigger enablement of Wake-Up Signaling (WUS);

FIG. 5D illustrates an example embodiment of actions performed by a UE for deactivating WUR and optionally WUS in response to certain conditions;

FIG. 5E illustrates an action performed by a UE for switching between different WURs in accordance with an embodiment of the present disclosure;

FIG. 5F illustrates one example embodiment of a process performed by a UE equipped with a MR and a WUR using a Reference Signal Received Power (RSRP) RSRP offset applied to a measured RSRP value;

FIG. 5G illustrates one example embodiment of a process performed by a UE equipped with a MR and a WUR using an RSRP offset applied to an RSRP threshold;

FIG. 6 shows an example illustrating a periodic pattern of low interference downlink time resources which can be configured in cell (e.g., Cell1) for WUR operation in that cell (e.g., Cell1), in accordance with an embodiment of the present disclosure;

FIG. 7 shows an example of a communication system in accordance with some embodiments;

FIG. 8 shows a UE in accordance with some embodiments;

FIG. 9 shows a network node in accordance with some embodiments;

FIG. 10 is a block diagram of a host, which may be an embodiment of the host of FIG. 7, in accordance with various aspects described herein;

FIG. 11 is a block diagram illustrating a virtualization environment in which functions implemented by some embodiments may be virtualized; and

FIG. 12 shows a communication diagram of a host communicating via a network node with a UE over a partially wireless connection in accordance with some embodiments.

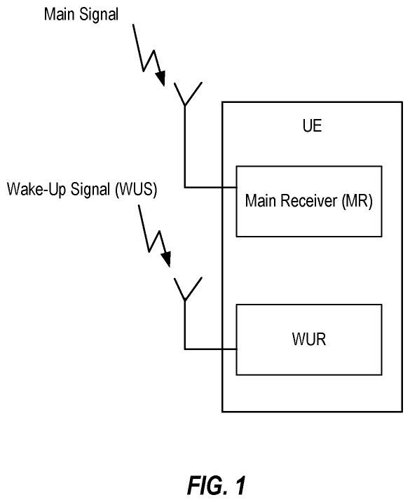

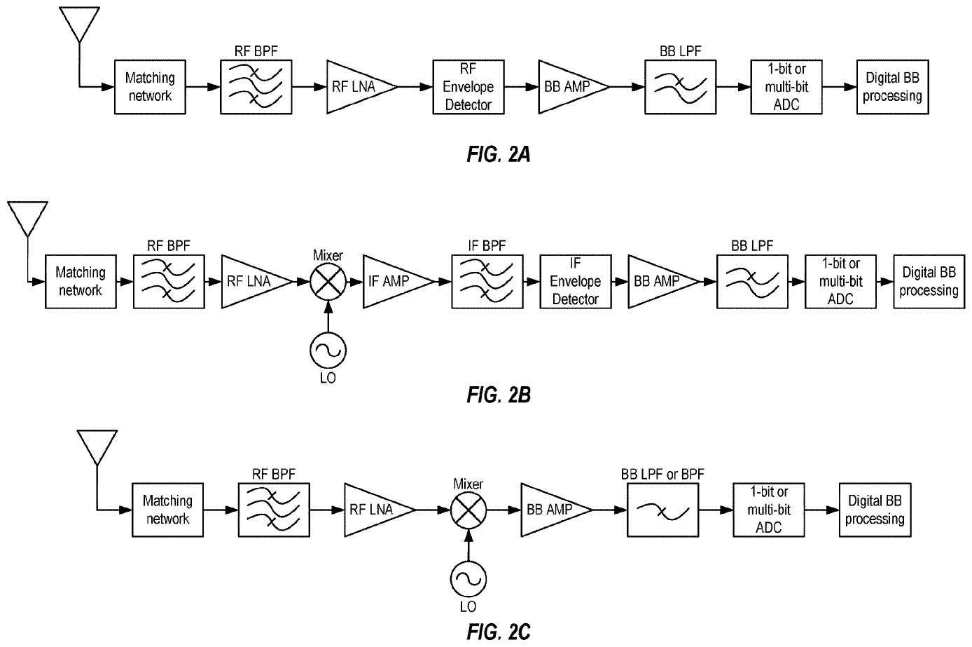

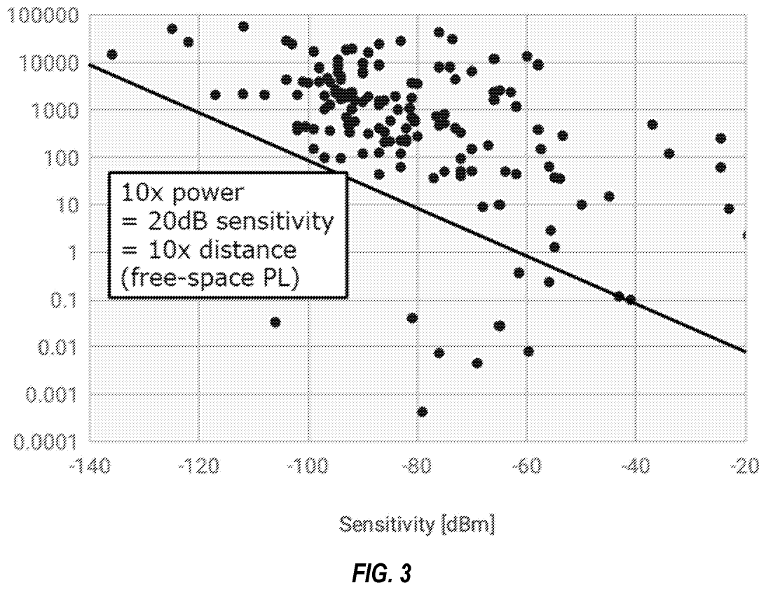

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s) in regard to a Wake-Up Receiver (WUR) in a 3rd Generation Partnership Project (3GPP) system. The WUR design target is to save power/reduce energy consumption. To achieve this, several WUR architectures are under discussion in the aforementioned 3GPP study item. It is reported in some studies that the WUR could have a high noise figure, which leads to high reference sensitivity (REFSENS) meaning the coverage of WUR may not be the same as that of the main receiver. To reduce energy consumption, this also means low Radio Frequency (RF) gain at the front-end. Some architectures could remove the Low-Noise Amplifier (LNA) for further power consumption reduction, depending on the use case. Another issue is that the receiver energy consumption may be high when receiving a weak wanted signal in the presence of strong interference. This relates to receiver linearity performance and, thus, to save more power, there is also a need to relax the linearity performance requirement. For example, the intermodulation response rejection may be relaxed as one of the User Equipment (UE) receiver requirements.

The radio condition and the blocker/interference environments will be the same for both the WUR and the main receiver since the WUR will be equipped in the same device as the main receiver. If the sensitivity is different for the WUR and the main receiver, there is a risk that the WUR will be “out of coverage” when the main receiver is not. In this case, when network sends the Wake-Up Signal (WUS) to such a UE, the WUS cannot be detected by the WUR, and hence the main receiver will not be woken up (i.e., out-of-WUR-coverage for the case with partial WUR coverage in the cell).

This will happen similarly when the WUR is saturated by stronger interferer/jammer/blocker, but the main receiver is not. In such case, if the network sends a WUS, the WUR cannot detect the WUS due to interference. Therefore, a mechanism is needed to cope with the problems described above to ensure the WUR is functioning as expected to achieve power savings while at the same time being able to wake-up the main receiver.

Certain aspects of the disclosure and their embodiments may provide solutions to these or other challenges. In one embodiment, a UE comprising both a WUR and a main receiver indicates (e.g., to a network node such as, e.g., a base station such as, e.g., a New Radio (NR) base station (gNB)) the capability of the WUR with reduced Radio Frequency (RF) performance (or reduced RF/Intermediate Frequency (IF) performance) in terms of REFSENS, selectivity, and/or intermodulation rejection performance compared to its main receiver. This type of WUR is sometimes referred to herein as a “type-1 WUR receiver”.

In another embodiment, a UE comprising both a WUR and a main receiver indicates (e.g., to a network node such as, e.g., a base station such as, e.g., a gNB) the capability of the WUR with the same RF performance (or same RF/IF performance) compared to its main receiver. This type of WUR is sometimes referred to herein as a “type-2 WUR”.

In one embodiment, a UE comprising both a WUR and a main receiver indicates the capability of the WUR by indicating a WUR type to the network. Here, the WUR type may be, e.g., either type-1 WUR or type-2 WUR as described above.

In one embodiment, the UE with the WUR enabled first reports its capability to the network (e.g., to a network node), and then the UE monitors a wanted radio quality or blocker or interferer signal level. When its wanted radio quality is lower than some threshold, the WUR is disabled or shut down, and the UE signals the network (e.g., sends a message or indication to a network node) to indicate the WUR is out of coverage and the main receiver is used instead. In this case, no WUS signal will be sent from the network side once the WUR is turned off at the UE side. Alternatively, the network is not notified that the WUR is turned off and switching on/off the WUR is a UE implementation choice. For example, when type-1 WUR is out of coverage, the UE enables the type-2 WUR if the UE is equipped with both type-1 or type-2 WUR. If the UE is not equipped with type-2 WUR (i.e., is only equipped with a type-1 WUR), the main receiver will be used. The UE decision on the switching on/off one type of WUR will be dependent on, e.g., WUR Reference Signal Received Power (RSRP) measurement.

In one embodiment, a method is disclosed herein that prevents a situation in which the WUR does not detect the WUS and wake up the main receiver, thus ensuring UE reachability. This may be achieved by criteria for the UE to switch the UE's receiver architecture or WUR usage, or the network to adapt the resources and coding used for the WUS.

Certain embodiments may provide one or more of the following technical advantage(s). Embodiments of the solution(s) described herein may enable a UE to make the trade-off between power saving and performance. This is done by introducing a mechanism of preventing the WUR from not detecting the WUS and waking up the main receiver, thereby ensuring UE reachability.

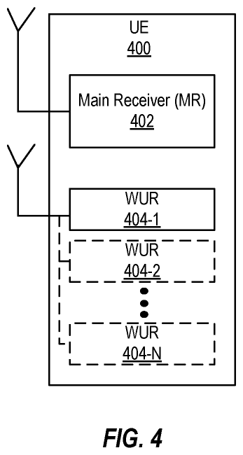

Systems and methods are disclosed herein that relate to a UE equipped with a main receiver (MR) and one or more Wake-Up Receivers (WURs). In this regard, FIG. 4 illustrates a UE 400 including a MR 402 and one or more WURs 404-1 to 404-N. Note that, in some embodiments, the UE 400 is equipped with only one WUR, which may be denoted herein as WUR 404 or 404-1. In other embodiments, the UE 400 is equipped with two or more WURs, which may be denoted herein as WURs 404-1 to 404-N, where, for example, different WURs may have different capabilities (e.g., different RF or IF capabilities). Thus, for ease of discussion, the WURs 404-1 to 404-N including one or more WURs is sometimes referred to herein as “WUR(s) 404”. Similarly, the term “WUR 404” is used herein to refer to a WUR of the UE 400 in general, regardless of whether the UE 400 is equipped with a single WUR or multiple WURs. The MR 402 and the WUR(s) 404 are separate receivers.

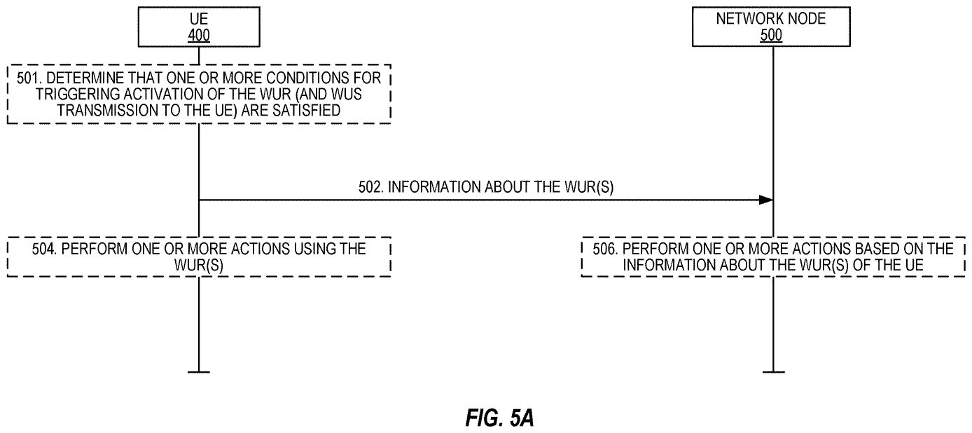

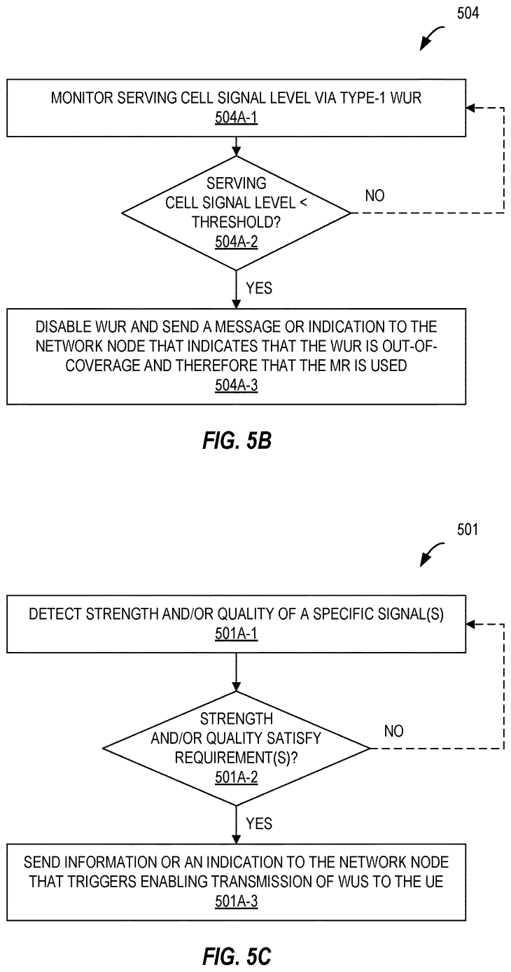

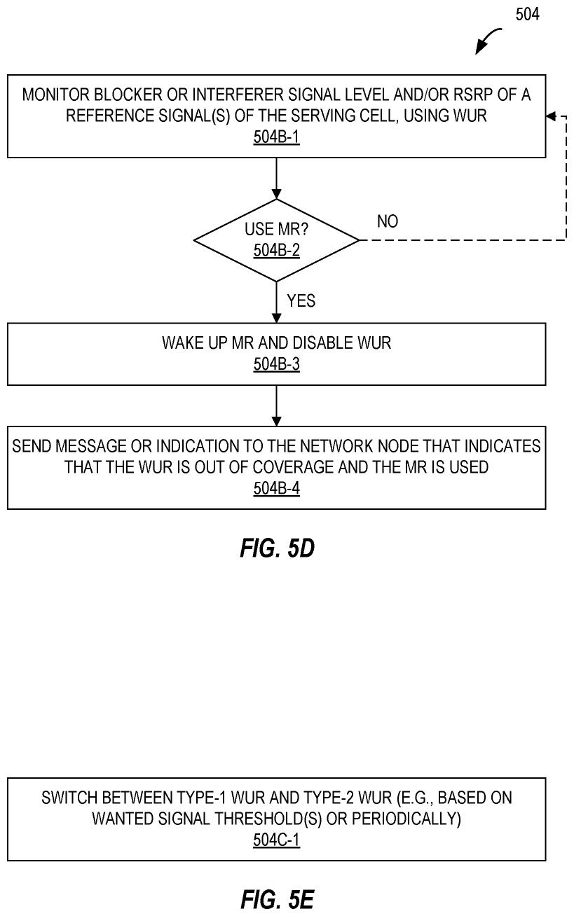

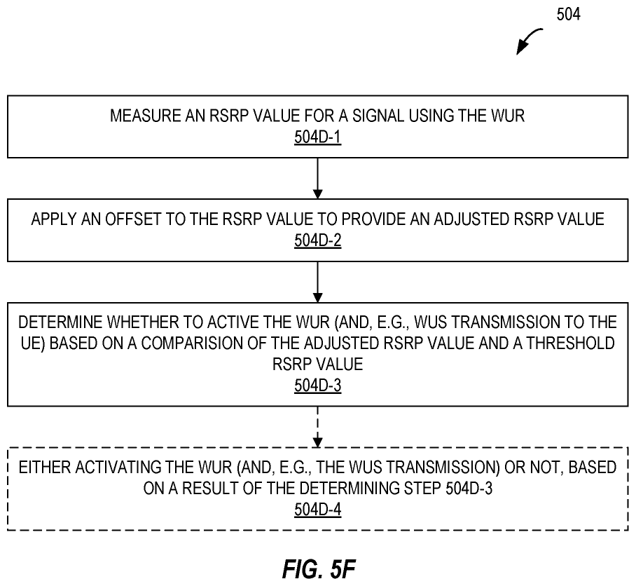

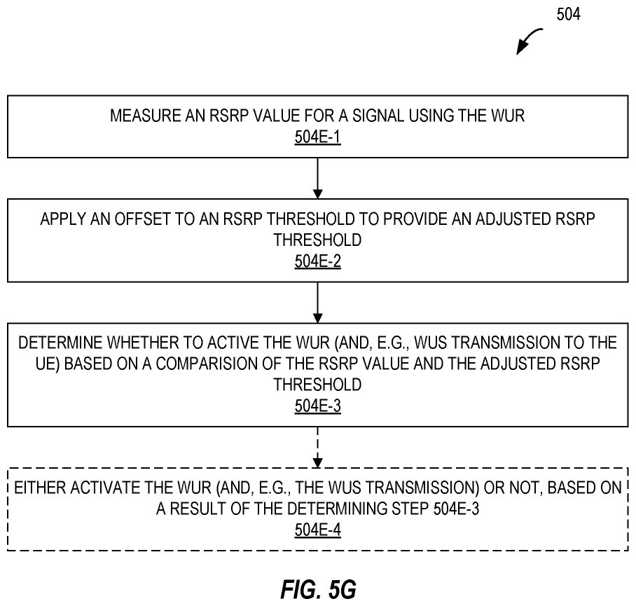

FIG. 5A illustrates the operation of the UE 400 and a network node 500 in accordance with at least some embodiments of the present disclosure. The network node 500 may be, e.g., a base station (e.g., a New Radio (NR) gNodeB (gNB) or a network node that performs some of the functionality of a base station such as, e.g., a gNB-Central Unit (CU) or gNB-Distributed Unit (DU)). Optional steps are represented by dashed lines/boxes. As illustrated, the UE 400 may determine whether one or more conditions for triggering activation of the WUR 404 and WUS transmission from the network node 500 to the UE 400 are satisfied (step 501). The UE 400 sends, to the network node 500, information about the WUR(s) 404 of the UE 400 (step 502). Note that if the UE 400 is equipped with multiple WURs 404-1 to 404-N, then the information sent to the network node 500 in step 502 may include separate information for each of the multiple WURs 404-1 to 404-N. Alternatively, the information sent to the network node 500 in step 502 may include information for only one of the multiple WURs 404-1 to 404-N that is currently enabled (i.e., turned on) at the UE 400. In one embodiment, the information sent in step 502 is sent by the UE 400 in response to step 501 in order triggering activation of WUS transmission from the network node 500 to the UE 400. The UE 400 may then perform one or more actions using the WUR(s) 404 (step 504). Examples of such actions are described below. The network node 500 may perform one or more actions based on the information received from the UE 400 in step 502 (step 506). Examples of such actions are described below.

In one embodiment, the WUR 404 has reduced RF performance (or reduced RF or IF performance) as compared to the MR 402, reduced selectivity as compared to the MR 402, and/or reduced intermodulation rejection performance as compared to the MR 402. In this case, the information sent by the UE 400 to the network node 500 in step 502 indicates that the UE 400 is equipped with a WUR having reduced RF performance (or reduced RF/IF performance) (e.g., in terms of REFSENS) as compared to the MR 402, reduced selectivity as compared to the MR 402, and/or reduced intermodulation rejection performance as compared the MR 402. In one embodiment, a WUR with this capability is referred to herein as a type-1 WUR.

In one embodiment, the WUR 404 has the same RF performance (or reduced RF or IF performance) as compared to the MR 402, the same selectivity as compared to the MR 402, and/or the same intermodulation rejection performance as compared to the MR 402. In this case, the information sent by the UE 400 to the network node 500 in step 502 indicates that the UE 400 is equipped with a WUR receiver having the same RF performance (or the same RF/IF performance), the same selectivity as compared to the MR 402, and/or the same intermodulation rejection performance as compared the MR 402. In one embodiment, a WUR with this capability is referred to herein as a type-2 WUR.

In one embodiment, the UE 400 equipped with a WUR 404 indicates its capability of a WUR to the network node 500 in step 502 in terms of RF capability (e.g., as part of the UE capability reporting, see below). In one example embodiment, the actions performed by the UE 400 in step 504 may include the following, as illustrated in FIG. 5B. The UE 400 is equipped with a type-1 WUR, and the UE 400 monitors the serving cell signal level using the type-1 WUR (e.g., synchronization signal strength and/or synchronization signal quality) (step 504A-1). When the serving cell signal level (e.g., synchronization signal strength and/or synchronization signal quality) is lower than a predefined or configured threshold(s) (step 504A-2, YES), the UE 400 disables or shuts-down the WUR 404 and sends (e.g., signals) a message or indication to the network node 500 that indicates the WUR 404 is out-of-coverage and the MR 402 is therefore used (step 504A-3). The threshold(s) may be configured by network via main radio, or configured by main radio directly, or pre-configured depending on the RF capability.

In one embodiment, the information sent by the UE 400 to the network node 500 in step 502 includes information that indicates one or more parameters of the WUR 404 such as, e.g., a noise figure, one or more filter parameters (e.g., bandwidth), and/or one or more clock impairments (e.g., maximum frequency error).

In one embodiment, the information sent by the UE 400 to the network node 500 in step 502 includes information about an architecture of the WUR 404, e.g., in terms of a LNA (e.g., number of LNAs and/or one or more associated parameters), Analog-to-Digital Conversion (ADC) (e.g., number of bits used for ADC (e.g., single bit or multi-bit ADC) and/or sampling rate), supported modulation scheme(s) (e.g., OOK, FSK, etc.), number of antennas, or any combination thereof.

In one embodiment, the properties in any of the preceding embodiments are grouped into different WUR classes, and in step 502 the UE 402 reports which WUR class(es) it supports, e.g., in UE capability reporting.

In another embodiment, the information sent by UE 402 to the network node 500 in step 502 includes information that indicates its WUR capability to the network node 500 in terms of the RF and/or IF capability of the WUR 404. In the case that the network (e.g., the network node 500) disables WUS transmission from the network to the WUR 404 of the UE 400. Further, as illustrated in FIG. 5C, the WUR 404 of the UE 400 is, in one embodiment, used to detect the strength and/or quality of a specific signal(s) (e.g., a synchronization signal, for example synchronization signal of serving cell) (step 501A-1). To save the power consumption, the UE 400 may enable the WUR 404 for this purpose instead of the MR 402. If the strength and/or quality of the specific signal satisfies one or more given requirements (e.g., higher than individual trigger thresholds) (step 501A-2, YES), then the UE 400 sends information or an indication to the network node 500 that triggers enabling transmission of the WUS to the UE 400 (step 501A-3). For example, in one embodiment, the UE sends the information in step 502 to the network node 500, which triggers the network node 500 to enable transmission of the WUS to the UE 400 (i.e., step 501A-3 of FIG. 5C is the same as (i.e., corresponds to, step 502 of FIG. 5A). The trigger threshold(s) may be configured by the network (e.g., by the network node 500), e.g., via main radio, or configured by main radio directly, or pre-configured. Note that, in one embodiment, these actions performed by the UE 400 are part of step 501, as illustrated in FIG. 5C.

As illustrated in FIG. 5D, in another embodiment (e.g., as part of step 504), the WUR 104 is a type-1 WUR, the UE 404 uses the WUR 404 to monitor the blocker or interferer signal level and/or RSRP of a reference signal(s) level of the serving cell (step 504B-1). In the case where the blocker/interfere level approaches a certain threshold and/or the wanted signal is below another threshold or the WUR 404 is saturated by the blocker/jammer/interferer signal (step 504B-2, YES), the UE 400 (e.g., the WUR 404) wakes up the MR 402, and the WUR 404 is disabled/shut down (step 504B-3). The UE 400 sends a message or indication (e.g., signaling) to the network node 500 that indicates that the WUR 404 is out of coverage and the MR 402 is used (step 504B-4). The threshold(s) may be configured by network via main radio, or configured by main radio directly, or pre-configured.

In another embodiment, the UE 400 reports, via the information sent to the network node 500 in step 502, both type-1 WUR and type-2 WUR. In one example embodiment, the type-2 WUR is implemented by reusing one or more components of the MR 402 and reducing the sampling rate of the reused components of the MR 402 to be tailored for receiving the WUS. As illustrated in FIG. 5E, in one embodiment (e.g., as part of step 504), the UE 400 switches between use of the type-1 WUR and type-2 WUR (step 504C-1). More specifically, in one embodiment (e.g., as part of step 504), when the wanted signal level is larger than one certain level, the type-1 WUR is enabled and, when wanted signal level is below another threshold, the type-2 WUR is enabled. In one embodiment, the UE performs the WUR switching itself without notifying the network. In another embodiment, the switching between type-1 WUR and type-2 WUR is done periodically to address the tradeoff between power consumption and sensitivity. The switching mechanism (e.g., periodicity) can be known to the network.

In another embodiment, a default WUR type (e.g., type-3 WUR) is defined which does not need any explicit indication (e.g., when the presence of WUR is known to the network). For example, if there is no indication for type1 WUR and type-2 WUR, the network assumes that type-3 WUR is used with pre-defined parameters/architecture/capabilities.

In above mentioned cases, in one embodiment, the network does not send a WUS but signals a DRX configuration to the UE 400 once the WUR 404 is turned off and the network is notified by the UE 400. If the serving cell signal level is above a certain threshold again, the WUS signal will be sent out to UE 400 once the WUR 404 of the UE 400 is enabled again. This is the case when the UE 400 is moving into WUR coverage area or blocking situation is lifted (blocker level reduced/disappeared).

In one embodiment, several classes of WUR are introduced, defined based on minimum requirements for the sensitivity. The UE 400 reports its WUR capability/class (e.g., in step 502) as an addition to the UE capabilities upon initial registration to the network (e.g., via the Attach procedure). In one embodiment (e.g., as part of step 506), the UE's WUR capability/class is then stored with the other UE capabilities in the UE context in the network (e.g., in the Access and Mobility Management Function (AMF) in a 5th Generation (5G) system), and upon paging communicated to the base station (e.g., gNB in the case of a 5G system including a NR RAN) (e.g., added to the ‘UE radio paging capabilities’). Based on this capability, the base station determines whether WUR operation is suitable for paging the UE.

In one embodiment (e.g., as part of step 501), the UE 400 uses an offset for the RSRP-threshold which determines if the UE 400 should use the WUR 404 (for monitoring for WUS) or not depending on if the RSRP measurement is done using the WUR 404 or the MR 402. In one example, the UE 400 applies an RSRP-threshold communicated to the UE 400 from the network (e.g., from the network node 500, e.g., in system information, or dedicated Radio Resource Control (RRC) signaling) corresponding to the UE's reported WUR class/type for the MR 402. If the measured RSRP is above the threshold, the UE 400 switches to monitoring WUS with the WUR 404 instead of legacy paging monitoring (if WUR operation is enabled for the UE 400, and supported in the cell). In WUR mode (e.g., in step 504), the UE 400 periodically measures RSRP with the WUR 400 and compares the measured RSRP to the configured RSRP-threshold, but now with an offset compensating for the difference in sensitivity between the MR 402 and the WUR 404. In one alternative, the offset to apply is calculated based on the difference in sensitivity between the MR 402 and the WUR 404. In another alternative, different RSRP-thresholds for the MR 402 and the WUR 404 for a WUR classed/types are explicitly signaled to the UE 400 (e.g., in system information or dedicated RRC). For example, the following may be signaled to the UE 400:

| WUR class: | MR RSRP-threshold: | WUR RSRP-threshold: |
|---|---|---|
| 1 | RSRP^{MR}₁ | RSRP^{WUR}₁ |
| 2 | RSRP^{MR}₂ | RSRP^{WUR}₂ |
| 3 | RSRP^{MR}₃ | RSRP^{WUR}₃ |

FIG. 5F illustrates one example embodiment of a process performed by the UE 400 using an RSRP offset applied to a measured RSRP value. As illustrated, the one or more actions performed in step 504 may include measuring an RSRP value for a signal using the WUR 404 (step 504D-1), applying an offset to the RSRP value to provide an adjusted RSRP value (step 504D-2), and determining whether to activate the WUR 404 (e.g., an WUS transmission) based on a comparison of the adjusted RSRP value and a threshold RSRP value (step 504D-3). The UE may then either activate the WUR 404 (e.g., and WUS transmission) or not based on the result of the determining step 504D-3 (step 504D-4). As discussed above, the offset compensates for differences in sensitivity between the WUR 404 and the MR 402 of the UE 400. Note that the process of FIG. 5F may alternatively be performed as part of step 501.

FIG. 5G illustrates one example embodiment of a process performed by the UE 400 using an RSRP offset applied to an RSRP threshold. As illustrated, the one or more actions performed in step 504 may include measuring an RSRP value for a signal using the WUR 404 (step 504E-1), applying an offset to an RSRP threshold to provide an adjusted RSRP threshold (step 504E-2), and determining whether to activate the WUR 404 (e.g., an WUS transmission) based on a comparison of the RSRP value and the adjusted RSPR threshold (step 504E-3). The UE may then either activate the WUR 404 (e.g., and WUS transmission) or not based on the result of the determining step 504E-3 (step 504E-4). As discussed above, the offset compensates for differences in sensitivity between the WUR 404 and the MR 402 of the UE 400. Note that the process of FIG. 5G may alternatively be performed as part of step 501.

Note that in one embodiment of the above (e.g., in step 504), the UE 400 implicitly switches between using the WUR 404 for downlink monitoring and using the MR 402 for downlink monitoring (i.e., legacy monitoring of paging). I.e. in this case there is no explicit signaling from UEs when they change coverage, which leads to both unwanted control signaling overhead in the cell and to unnecessary UE energy consumption. The RSRP-threshold corresponding to the UE's WUR class in this way determines when (in which part of the cell) the UE 400 should use the WUR 404 for monitoring the downlink, but the paging is left to network implementation (i.e. whether to use WUS or legacy paging, which is not worse than in legacy since it is not clear that the UE 400 is in the cell, or with the use of different Coverage Enhancement levels for paging).

In yet another embodiment (e.g., as part of step 504), in the UE 400, the selection of receiver type (e.g., MR, WUR or WUR type1, WUR type2) depends on one or more rules according to any one or more of the following:
Whether the UE 400 has met the cell selection criterion S (also known as cell suitability criterion or S-criterion). If the UE 400 has met the cell selection criterion S, then the UE 400 continues to use the WUR 404. However, if the UE 400 has failed to meet the cell selection criterion, then the UE 400 suspends the use of the WUR 404 for a period of time Tn, as a special case Tn−0. The rationale for suspending the use of the WUR 404 is that, if the coverage of the serving cell is impacted and a cell change may be triggered, it is better to use the MR 402 as it may provide improved coverage and/or reliability.
   A proposed specification text for how the above UE behavior can be captured in 3GPP TS 38.133 is shown below. Note that main receiver refers to the legacy or reference receiver as described in clause 2.2.1.

4.2.x.y Measurement and evaluation of serving cell
[...]
If the UE has evaluated according to Table 4.2.2.2-1 in Nₛₑᵣᵥ consecutive DRX
cycles that the serving cell does not fulfil the cell selection criterion S, the UE
shall meet the requirements using the main receiver regardless of any rules
limiting use of receiver type.

Whether a cell change is ongoing or is to be triggered/initiated. Examples of cell change are cell reselection, handover, RRC connection release with redirection, RRC connection re-establishment etc. When a cell change is ongoing or is to be triggered/initiated, then the UE 400 suspends the use of the WUR 404 and starts using the MR 402 until the cell change is completed (e.g., until the UE 400 is capable to start monitoring the downlink channels of the target cells). Otherwise, if no cell change is ongoing or to be triggered (e.g., within the next T1 time duration), then the UE 400 may continue using the WUR 404. The rationale for suspending the use of the WUR 404 and to start using the MR 402 is that the UE 400 may experience poor coverage in the current cell and therefore it is better to use the MR 402 as it may provide improved coverage and/or reliability. Another reason is that use of the MR 402 can speed up the cell change procedure, e.g. the UE 400 may be able to detect the target cells faster when using the MR 402 compared to using the WUR 404 because of the higher Signal to Interference plus Noise Ratio (SINR) conditions.

In further embodiments, the network (e.g., the network node 500, e.g., in step 506) uses information signaled from the UE 400 (e.g., the information signaled in step 502), which may include the WUR capability, the WUR capabilities in terms of baseband and RF architecture and sensitivity, reported RSRP or signal strength or out of coverage information sent to the network to adapt the resources and coding used for the WUS signal. This may include:
Allocating a different amount of gNB power to the WUS
Changing the amount of repetition of the WUS, if applicable
Changing the coding performed on the WUS

In this way, by adapting the coding and resources spent on the WUS the network may be able to enable certain UEs to continue to use the WUR and enjoy power saving benefits whilst there received signal strength is decreased or increased interference is experienced.

In another embodiment (e.g., in step 506), the network node 500 configures a pattern of time domain resources in a cell during which (i.e. during the pattern resources) the UE 400 is expected to receive the signals (e.g. WUS) in that cell. The time domain pattern may be periodic or aperiodic. For example, the periodic pattern comprises of periodic occurrence of the radio resources (e.g., symbols, slots, subframes etc.) in which the downlink (DL) signals such as WUS are transmitted and in which the received signal level (RSL) of the DL (e.g., such as the WUS) at the UE 400 is above a threshold. These resources may also be referred to as “low interference time resources”. The use of the WUR 404 during the low interference time resources enables the UE 400 to correctly receive/decode and process the DL signals (e.g., WUS). Examples of RSL are received signal strength (RSS), received signal quality (RSQ) etc. Examples of RSL are RSRP, path loss etc. Examples of RSQ are RSRQ, SNR, SINR etc. It may however be left up to the UE 400 whether to use the WUR 404 or use the MR 402 during the low interference time resources for the WUS reception or for the reception of other DL signals. The network node 500 may realize or ensure low interference in the ‘low interference time resources’ by one or more of the following mechanisms:
By transmitting the DL signals (e.g., WUS) using higher power, e.g. transmit power above certain threshold,
By transmitting the information about the pattern used or expected to be used in a cell (e.g., Cell1) to a second network node (NW2, e.g. neighbor base station), which manages at least one cell (e.g., Cell2). In one example, NW2 ensures that Cell2 does not transmit any DL signal during the low interference time resources of the pattern used in Cell1. In another example, NW2 ensures that Cell2 transmits the DL signals with a transmit power below certain threshold during the low interference time resources of the pattern used in Cell1. In this way low interference is generated by the UE receiving DL signals in Cell1 during the low interference time resources.

The information about the pattern for the cell (e.g., Cell1) can be transmitted in a system information (SI) (e.g., SIB) etc. The UE 400 obtains the pattern information by acquiring/receiving the SI of the cell, e.g. via RRC message. The information enables the UE 400 to identify the timing of the pattern, e.g. when the pattern starts, when the pattern ends, timing or occurrence of the low time resources within the pattern etc. The timing information may be expressed in terms of one or more of: universal time (e.g., UTC time), network or cell timing (e.g., one or more of SFN, hyper SFN (H-SFN), slot number, subframe number etc.). The UE uses the obtained information for activating the WUR or activating the main receiver and uses the activated receiver for receiving the DL signals in that cell, e.g. WUR for receiving signals during the low interference time resources and main receiver for receiving signals during the normal time resources (i.e., in which low interference is not guaranteed).

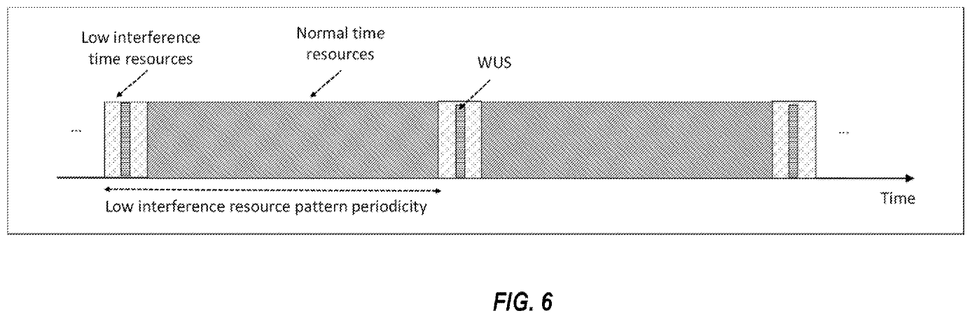

An example illustrating a periodic pattern of low interference DL time resources which can be configured in cell (e.g., Cell1) for WUR operation in that cell (e.g., Cell1) is shown in FIG. 6. During the low interference time resources, the cell (e.g. Cell1) can transmit DL signals (e.g. WUS) with higher power (e.g. above a threshold) and/or ensures that at least one neighboring cell (e.g. Cell2) does not transmits DL signals in that cell (e.g. Cell2) or transmits DL signals in that cell (e.g. Cell2) with transmit power below certain threshold. However, during the remaining DL time resources (i.e., normal time resources), Cell1 cannot guarantee low interference.

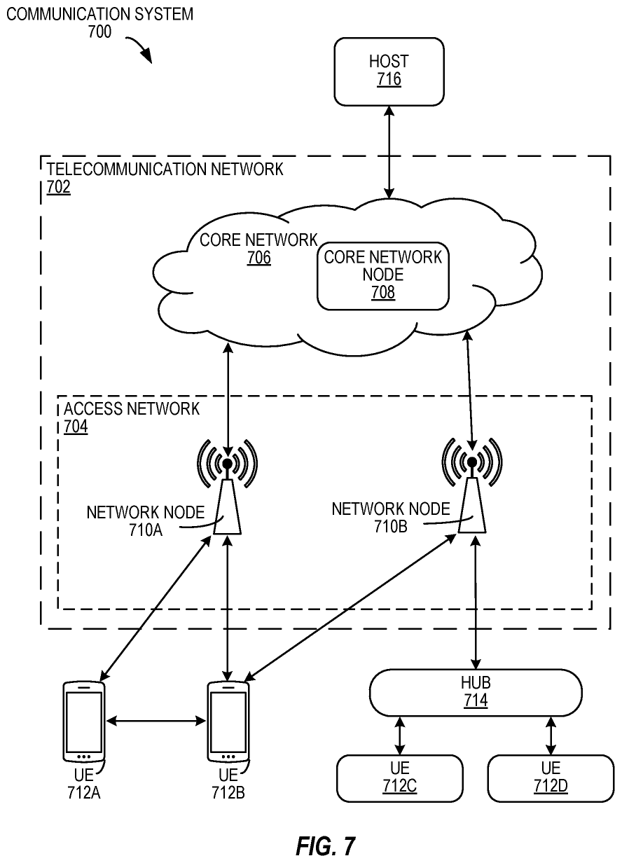

FIG. 7 shows an example of a communication system 700 in accordance with some embodiments.

In the example, the communication system 700 includes a telecommunication network 702 that includes an access network 704, such as a Radio Access Network (RAN), and a core network 706, which includes one or more core network nodes 708. The access network 704 includes one or more access network nodes, such as network nodes 710A and 710B (one or more of which may be generally referred to as network nodes 710), or any other similar Third Generation Partnership Project (3GPP) access node or non-3GPP Access Point (AP). The network nodes 710 facilitate direct or indirect connection of User Equipment (UE), such as by connecting UEs 712A, 712B, 712C, and 712D (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system 700 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 702 is a cellular network that implements 3GPP standardized features. Accordingly, the telecommunication network 702 may support network slicing to provide different logical networks to different devices that are connected to the telecommunication network 702. For example, the telecommunication network 702 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 714 communicates with the access network 704 to facilitate indirect communication between one or more UEs (e.g., UE 712C and/or 712D) and network nodes (e.g., network node 710B). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a Virtual Reality (VR) headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710B. The hub 714 may also allow for a different communication scheme and/or schedule between the hub 714 and UEs (e.g., UE 712C and/or 712D), and between the hub 714 and the core network 706. In other examples, the hub 714 is connected to the core network 706 and/or one or more UEs via a wired connection. Moreover, the hub 714 may be configured to connect to a Machine-to-Machine (M2M) service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710B. In other embodiments, the hub 714 may be a non-dedicated hub—that is, a device which is capable of operating to route communications between the UEs and the network node 710B, but which is additionally capable of operating as a communication start and/or end point for certain data channels.

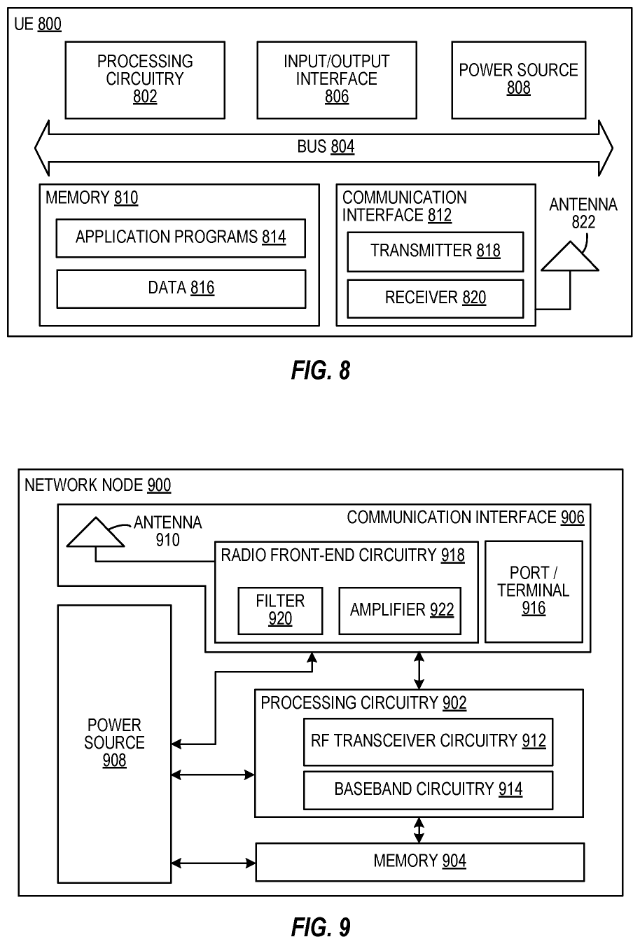

FIG. 8 shows a UE 800 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 802 may include multiple Central Processing Units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device. In some embodiments, the power source 808 is structured as a battery or battery pack.

Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging the power source 808. Power circuitry may perform any formatting, converting, or other modification to the power from the power source 808 to make the power suitable for the respective components of the UE 800 to which power is supplied.

The memory 810 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 810 may allow the UE 800 to access instructions, application programs, and the like stored on transitory or non-transitory memory media, to off-load data, or to upload data. An article of manufacture, such as one utilizing a communication system, may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., the antenna 822) and may share circuit components, software, or firmware, or alternatively be implemented separately.

In the illustrated embodiment, communication functions of the communication interface 812 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 812, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 9 shows a network node 900 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes processing circuitry 902, memory 904, a communication interface 906, and a power source 908. The network node 900 may be composed of multiple physically separate components (e.g., a Node B component and an RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 900 may be configured to support multiple RATs. In such embodiments, some components may be duplicated (e.g., separate memory 904 for different RATs) and some components may be reused (e.g., an antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 900.

The processing circuitry 902 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 900 components, such as the memory 904, to provide network node 900 functionality.

In some embodiments, the processing circuitry 902 includes a System on a Chip (SOC). In some embodiments, the processing circuitry 902 includes one or more of Radio Frequency (RF) transceiver circuitry 912 and baseband processing circuitry 914. In some embodiments, the RF transceiver circuitry 912 and the baseband processing circuitry 914 may be on separate chips (or sets of chips), boards, or units, such as radio units and digital units. In alternative embodiments, part or all of the RF transceiver circuitry 912 and the baseband processing circuitry 914 may be on the same chip or set of chips, boards, or units.

The memory 904 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and the memory 904 are integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. The radio front-end circuitry 918 comprises filters 920 and amplifiers 922. The radio front-end circuitry 918 may be connected to the antenna 910 and the processing circuitry 902. The radio front-end circuitry 918 may be configured to condition signals communicated between the antenna 910 and the processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of the filters 920 and/or the amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface 906 may comprise different components and/or different combinations of components.

In certain alternative embodiments, the network node 900 does not include separate radio front-end circuitry 918; instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes the one or more ports or terminals 916, the radio front-end circuitry 918, and the RF transceiver circuitry 912 as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, the communication interface 906, and/or the processing circuitry 902 may be configured to perform any receiving operations and/or certain obtaining operations described herein as being performed by the network node 900. Any information, data, and/or signals may be received from a UE, another network node, and/or any other network equipment. Similarly, the antenna 910, the communication interface 906, and/or the processing circuitry 902 may be configured to perform any transmitting operations described herein as being performed by the network node 900. Any information, data, and/or signals may be transmitted to a UE, another network node, and/or any other network equipment.

The power source 908 provides power to the various components of the network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid or an electricity outlet) via input circuitry or an interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

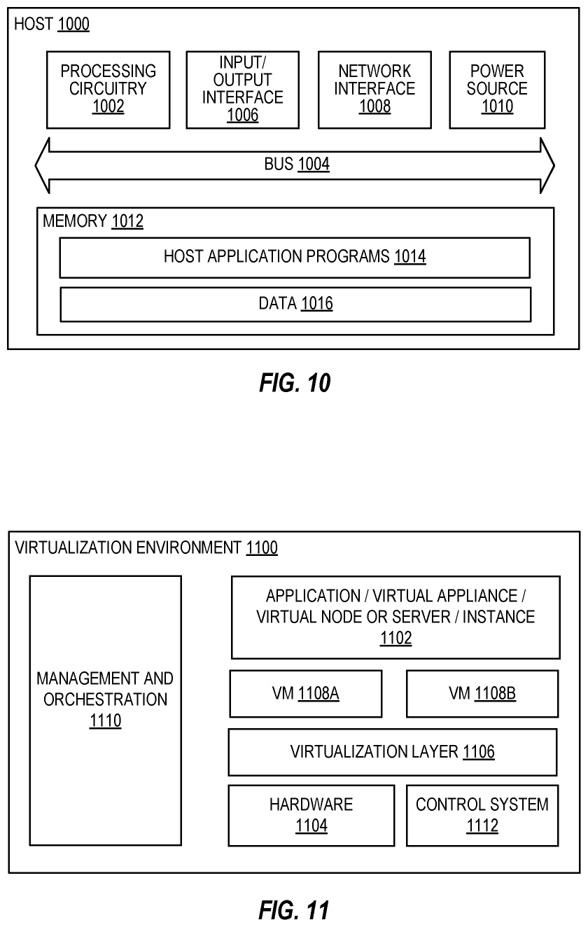

FIG. 10 is a block diagram of a host 1000, which may be an embodiment of the host 716 of FIG. 7, in accordance with various aspects described herein. As used herein, the host 1000 may be or comprise various combinations of hardware and/or software including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and memory 1012. Other components may be included in other embodiments. Features of these components may be substantially similar to those described with respect to the devices of previous figures, such as FIGS. 8 and 9, such that the descriptions thereof are generally applicable to the corresponding components of the host 1000.

The memory 1012 may include one or more computer programs including one or more host application programs 1014 and data 1016, which may include user data, e.g. data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for Over-The-Top (OTT) services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

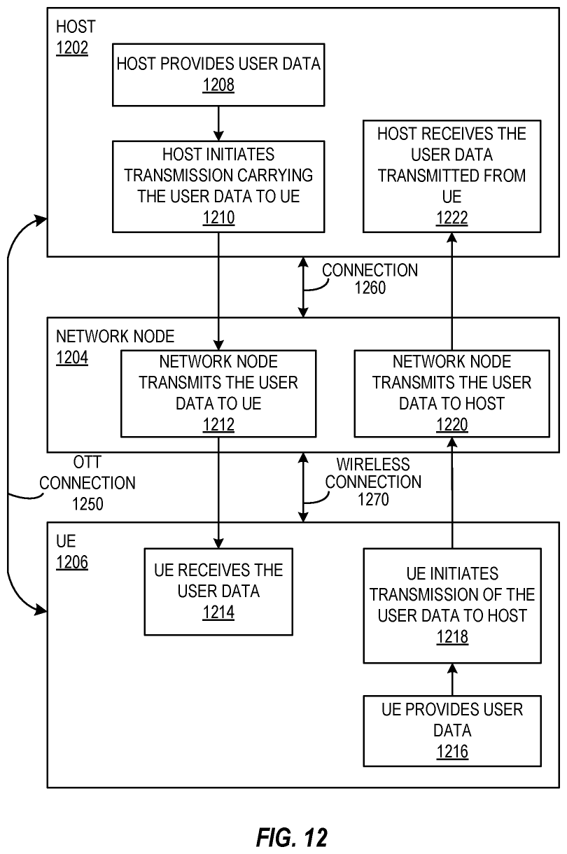

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment 1100 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or VM Monitors (VMMs)), provide VMs 1108A and 1108B (one or more of which may be generally referred to as VMs 1108), and/or perform any of the functions, features, and/or benefits described in relation with some embodiments described herein. The virtualization layer 1106 may present a virtual operating platform that appears like networking hardware to the VMs 1108.

The VMs 1108 comprise virtual processing, virtual memory, virtual networking, or interface and virtual storage, and may be run by a corresponding virtualization layer 1106. Different embodiments of the instance of a virtual appliance 1102 may be implemented on one or more of the VMs 1108, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1108 may be a software implementation of a physical machine that runs programs as if they were executing on a physical, non-virtualized machine. Each of the VMs 1108, and that part of the hardware 1104 that executes that VM, be it hardware dedicated to that VM and/or hardware shared by that VM with others of the VMs 1108, forms separate virtual network elements. Still in the context of NFV, a virtual network function is responsible for handling specific network functions that run in one or more VMs 1108 on top of the hardware 1104 and corresponds to the application 1102.

The hardware 1104 may be implemented in a standalone network node with generic or specific components. The hardware 1104 may implement some functions via virtualization. Alternatively, the hardware 1104 may be part of a larger cluster of hardware (e.g., such as in a data center or CPE) where many hardware nodes work together and are managed via management and orchestration 1110, which, among others, oversees lifecycle management of the applications 1102. In some embodiments, the hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1112 which may alternatively be used for communication between hardware nodes and radio units.

FIG. 12 shows a communication diagram of a host 1202 communicating via a network node 1204 with a UE 1206 over a partially wireless connection in accordance with some embodiments. Example implementations, in accordance with various embodiments, of the UE (such as the UE 712A of FIG. 7 and/or the UE 800 of FIG. 8), the network node (such as the network node 710A of FIG. 7 and/or the network node 900 of FIG. 9), and the host (such as the host 716 of FIG. 7 and/or the host 1000 of FIG. 10) discussed in the preceding paragraphs will now be described with reference to FIG. 12.

Like the host 1000, embodiments of the host 1202 include hardware, such as a communication interface, processing circuitry, and memory. The host 1202 also includes software, which is stored in or is accessible by the host 1202 and executable by the processing circuitry. The software includes a host application that may be operable to provide a service to a remote user, such as the UE 1206 connecting via an OTT connection 1250 extending between the UE 1206 and the host 1202. In providing the service to the remote user, a host application may provide user data which is transmitted using the OTT connection 1250.

The network node 1204 includes hardware enabling it to communicate with the host 1202 and the UE 1206 via a connection 1260. The connection 1260 may be direct or pass through a core network (like the core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by the UE 1206 and executable by the UE's processing circuitry. The software includes a client application, such as a web browser or operator-specific “app” that may be operable to provide a service to a human or non-human user via the UE 1206 with the support of the host 1202. In the host 1202, an executing host application may communicate with the executing client application via the OTT connection 1250 terminating at the UE 1206 and the host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via the connection 1260 between the host 1202 and the network node 1204 and via a wireless connection 1270 between the network node 1204 and the UE 1206 to provide the connection between the host 1202 and the UE 1206. The connection 1260 and the wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204 in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may improve, e.g., power consumption (i.e., reduce power consumption) and thereby provide benefits such as, e.g., extended battery lifetime.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR, or AR which it can broadcast, multicast, or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1250 between the host 1202 and the UE 1206 in response to variations in the measurement results. The measurement procedure and/or the network functionality for reconfiguring the OTT connection 1250 may be implemented in software and hardware of the host 1202 and/or the UE 1206. In some embodiments, sensors (not shown) may be deployed in or in association with other devices through which the OTT connection 1250 passes; the sensors may participate in the measurement procedure by supplying values of the monitored quantities exemplified above, or by supplying values of other physical quantities from which software may compute or estimate the monitored quantities. The reconfiguring of the OTT connection 1250 may include message format, retransmission settings, preferred routing, etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency, and the like by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### Group A Embodiments

Embodiment 1: A method performed by a User Equipment, UE, (400) equipped with a main receiver (402) and one or more wake-up receivers, WURs, (404), the method comprising: sending (502), to a network node (500), information about the one or more WURs (404) of the UE (400).

Embodiment 2: The method embodiment 1 wherein the information about the one or more WURs (404) of the UE (400) comprises information that indicates one or more WUR types of the one or more WURs (404) of the UE (400).

Embodiment 3: The method of embodiment 2 wherein the one or more WUR types indicated by the information are from a plurality of defined WUR types each associated to one or more different sets of WUR related parameters.

Embodiment 4: The method of embodiment 3 wherein WUR related parameters comprise radio frequency or intermediate frequency performance, selectivity, and/or intermodulation rejection performance.

Embodiment 5: The method of embodiment 1 wherein the information about the one or more WURs (404) of the UE (400) comprises, for each WUR of the one or more WURs (404), information that indicates whether the radio frequency or intermediate frequency performance of the WUR is reduced as compared to that of the main receiver (402), information that indicates whether a selectivity of the WUR is reduced as compared to that of the main receiver (402), and/or information that indicates whether an intermodulation rejection performance of the WUR is reduced as compared to that of the main receiver (402).

Embodiment 6: The method of embodiment 1 or 5 wherein the information about the one or more WURs (404) of the UE (400) comprises, for each WUR of the one or more WURs (404), information that indicates whether the radio frequency or intermediate frequency performance of the WUR is the same as that of the main receiver (402), information that indicates whether a selectivity of the WUR is the same as that of the main receiver (402), and/or information that indicates whether an intermodulation rejection performance of the WUR is the same as that of the main receiver (402).

Embodiment 7: The method of embodiment 1, 5, or 6 wherein the information about the one or more WURs (404) of the UE (400) comprises, for each WUR of the one or more WURs (404), information that indicates one or more parameters of the WUR.

Embodiment 8: The method of embodiment 7 wherein the one or more parameters of the WUR comprise a noise figure of the WUR, one or more filtering parameters of one or more filters of the WUR, and/or one or more clock impairments of the WUR.

Embodiment 9: The method of any of embodiments 1 and 5-8 wherein the information about the one or more WURs (404) of the UE (400) comprises, for each WUR of the one or more WURs (404), information about an architecture of the WUR.

Embodiment 10: The method of embodiment 9 wherein the information about the architecture of the WUR is in terms of low-noise amplifier(s), analog-to-digital conversion, supported modulation scheme(s), and/or number of antennas.

Embodiment 11: The method of any of embodiments 1 and 5-10 wherein the information about the one or more WURs (404) of the UE (400) comprises, for each WUR of the one or more WURs (404), information about one or more radio frequency capabilities of the WUR and/or information about one or more intermediate frequency capabilities of the WUR.

Embodiment 12: The method of any of embodiments 1 to 11 wherein the one or more WURs comprise two or more WURs.

Embodiment 13: The method of any of embodiments 1 to 12 further comprising performing (504) one or more actions using the one or more WURs.

Embodiment 14: The method of embodiment 13 wherein the one or more actions using the one or more WURs comprise: measuring a signal strength or quality of one or more signals using a WUR; and determining whether to activate or deactivate the WUR based on the measured signal strength or quality of the one or more signals.

Embodiment 15: The method of embodiment 14 wherein the one or more actions further comprise, responsive to determining to activate the WUR, sending a message or indication to the network node to trigger activation of transmission of wake-up signals to the UE (400).

Embodiment 16: The method of embodiment 14 wherein the one or more actions further comprise, responsive to determining to deactivate the WUR, deactivating the WUR (e.g., with respect to monitoring for a WUS).

Embodiment 17: The method of embodiment 14 wherein the one or more actions further comprise, responsive to determining to deactivate the WUR, sending a message or indication to the network node that indicates that the WUR has been deactivated (e.g., and that the UE (400) is using the main receiver).

Embodiment 18: The method of embodiment 13 wherein the one or more WURs comprise two or more WURs, and the one or more actions comprise switching between the two or more WURs in accordance with one or more rules.

Embodiment 19: The method of embodiment 13 wherein the one or more WURs comprise two or more WURs, and the one or more actions comprise periodically switching between the two or more WURs.

Embodiment 20: The method of embodiment 13 wherein the one or more actions using the one or more WURs comprise: measuring (504D-1) a RSRP value for a signal using a WUR; applying (504D-2) an offset to the RSRP value to provide an adjusted RSRP value; determining (504D-3) whether to activate the WUR (e.g., and WUS transmission) based on a comparison of the adjusted RSRP value and a threshold RSRP value.

Embodiment 21: The method of embodiment 13 wherein the one or more actions using the one or more WURs comprise: measuring (504E-1) a RSRP value for a signal using a WUR; applying (504E-2) an offset to a threshold RSRP value to provide an adjusted threshold RSRP value; determining (504E-3) whether to the activate the WUR (e.g., and WUS transmission) based on a comparison of the RSRP value and the adjusted threshold RSRP value.

Embodiment 22: The method of embodiment 20 or 21 wherein the offset compensates for difference in sensitivity between the WUR and the main receiver of the UE.

Embodiment 23: The method of any of the previous embodiments, further comprising: providing user data; and forwarding the user data to a host via the transmission to the network node.

### Group B Embodiments

Embodiment 24: A method performed by a network node (500), the method comprising: receiving (502), from a User Equipment, UE, (400), information about one or more wake-up receivers, WURs, of the UE (400), wherein the UE (400) is equipped with the one or more WURs (404) and a main receiver (402).

Embodiment 25: The method embodiment 24 wherein the information about the one or more WURs (404) of the UE (400) comprises information that indicates one or more WUR types of the one or more WURs (404) of the UE (400).

Embodiment 26: The method of embodiment 25 wherein the one or more WUR types indicated by the information are from a plurality of defined WUR types each associated to one or more different sets of WUR related parameters.

Embodiment 27: The method of embodiment 26 wherein WUR related parameters comprise radio frequency or intermediate frequency performance, selectivity, and/or intermodulation rejection performance.

Embodiment 28: The method of embodiment 24 wherein the information about the one or more WURs (404) of the UE (400) comprises, for each WUR of the one or more WURs (404), information that indicates whether the radio frequency or intermediate frequency performance of the WUR is reduced as compared to that of the main receiver (402), information that indicates whether a selectivity of the WUR is reduced as compared to that of the main receiver (402), and/or information that indicates whether an intermodulation rejection performance of the WUR is reduced as compared to that of the main receiver (402).

Embodiment 29: The method of embodiment 24 or 28 wherein the information about the one or more WURs (404) of the UE (400) comprises, for each WUR of the one or more WURs (404), information that indicates whether the radio frequency or intermediate frequency performance of the WUR is the same as that of the main receiver (402), information that indicates whether a selectivity of the WUR is the same as that of the main receiver (402), and/or information that indicates whether an intermodulation rejection performance of the WUR is the same as that of the main receiver (402).

Embodiment 30: The method of embodiment 24, 28, or 29 wherein the information about the one or more WURs (404) of the UE (400) comprises, for each WUR of the one or more WURs (404), information that indicates one or more parameters of the WUR.

Embodiment 31: The method of embodiment 30 wherein the one or more parameters of the WUR comprise a noise figure of the WUR, one or more filtering parameters of one or more filters of the WUR, and/or one or more clock impairments of the WUR.

Embodiment 32: The method of any of embodiments 24 and 28-31 wherein the information about the one or more WURs (404) of the UE (400) comprises, for each WUR of the one or more WURs (404), information about an architecture of the WUR.

Embodiment 33: The method of embodiment 32 wherein the information about the architecture of the WUR is in terms of low-noise amplifier(s), analog-to-digital conversion, supported modulation scheme(s), and/or number of antennas.

Embodiment 34: The method of any of embodiments 24 and 28-33 wherein the information about the one or more WURs (404) of the UE (400) comprises, for each WUR of the one or more WURs (404), information about one or more radio frequency capabilities of the WUR and/or information about one or more intermediate frequency capabilities of the WUR.

Embodiment 35: The method of any of embodiments 24 to 34 wherein the one or more WURs comprise two or more WURs.

Embodiment 36: The method of any of embodiments 24 to 35 further comprising performing (506) one or more actions based on the information about the one or more WURs (404) of the UE (400).

Embodiment 37: The method of embodiment 36 wherein the one or more actions comprise activating transmission of wake-up signals to the UE (400).

Embodiment 38: The method of embodiment 36 wherein the one or more actions comprise storing at least some of the information about the WURs in a UE context of the UE (400).

Embodiment 39: The method of embodiment 38 wherein the one or more actions further comprise sending the information about the WURs of the UE (400) to another network node.

Embodiment 40: The method of embodiment 36 wherein the one or more actions comprise adapting resources and/or coding used for WUS transmission to the UE (400) based on the information about the WURs of the UE (400).

Embodiment 41: The method of any of the previous embodiments, further comprising: obtaining user data; and forwarding the user data to a host or a user equipment.

### Group C Embodiments

Embodiment 42: A user equipment comprising: processing circuitry configured to perform any of the steps of any of the Group A embodiments; and power supply circuitry configured to supply power to the processing circuitry.

Embodiment 43: A network node comprising: processing circuitry configured to perform any of the steps of any of the Group B embodiments; and power supply circuitry configured to supply power to the processing circuitry.

Embodiment 44: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 45: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 46: The host of the previous embodiment, wherein the cellular network further includes a network node configured to communicate with the UE to transmit the user data to the UE from the host.

Embodiment 47: The host of the previous 2 embodiments, wherein: the processing circuitry of the host is configured to execute a host application, thereby providing the user data; and the host application is configured to interact with a client application executing on the UE, the client application being associated with the host application.

Embodiment 48: A method implemented by a host operating in a communication system that further includes a network node and a user equipment (UE), the method comprising:

providing user data for the UE; and initiating a transmission carrying the user data to the UE via a cellular network comprising the network node, wherein the UE performs any of the operations of any of the Group A embodiments to receive the user data from the host.

Embodiment 49: The method of the previous embodiment, further comprising: at the host, executing a host application associated with a client application executing on the UE to receive the user data from the UE.

Embodiment 50: The method of the previous embodiment, further comprising: at the host, transmitting input data to the client application executing on the UE, the input data being provided by executing the host application, wherein the user data is provided by the client application in response to the input data from the host application.

Embodiment 51: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 52: The host of the previous embodiment, wherein the cellular network further includes a network node configured to communicate with the UE to transmit the user data from the UE to the host.

Embodiment 53: The host of the previous 2 embodiments, wherein: the processing circuitry of the host is configured to execute a host application, thereby providing the user data; and the host application is configured to interact with a client application executing on the UE, the client application being associated with the host application.

Embodiment 54: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 55: The method of the previous embodiment, further comprising: at the host, executing a host application associated with a client application executing on the UE to receive the user data from the UE.

Embodiment 56: The method of the previous embodiment, further comprising: at the host, transmitting input data to the client application executing on the UE, the input data being provided by executing the host application, wherein the user data is provided by the client application in response to the input data from the host application.

Embodiment 57: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 58: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 59: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 60: The method of the previous embodiment, further comprising, at the network node, transmitting the user data provided by the host for the UE.

Embodiment 61: The method of any of the previous 2 embodiments, wherein the user data is provided at the host by executing a host application that interacts with a client application executing on the UE, the client application being associated with the host application.

Embodiment 62: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 63: The communication system of the previous embodiment, further comprising: the network node; and/or the user equipment.

Embodiment 64: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 65: The host of the previous 2 embodiments, wherein: the processing circuitry of the host is configured to execute a host application, thereby providing the user data; and the host application is configured to interact with a client application executing on the UE, the client application being associated with the host application.

Embodiment 66: The host of the any of the previous 2 embodiments, wherein the initiating receipt of the user data comprises requesting the user data.

Embodiment 67: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 68: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE) equipped with a main receiver and one or more wake-up receivers (WURs) the method comprising:
sending, to a network node, information about the one or more WURs of the UE, wherein, for each WUR of the one or more WURs, the information indicates:
(a) whether the radio frequency or intermediate frequency performance of the WUR is reduced as compared to or the same as that of the main receiver;
(b) whether a selectivity of the WUR is reduced as compared to or the same as that of the main receiver;
(c) whether an intermodulation rejection performance of the WUR is reduced as compared to or the same as that of the main receiver;
(d) whether a sensitivity of the WUR is reduced as compared to or the same as that of the main receiver;
(e) information about an architecture of the WUR;
(f) a WUR type of the WUR;
(g) one or more parameters of the WUR;
(h) information about one or more radio frequency capabilities of the WUR and/or information about one or more intermediate frequency capabilities of the WUR; or
(i) any combination of two or more of (a)-(h).

2. The method of claim 1, wherein, for each WUR of the one or more WURs, the information comprises any one or more of the following:
information that indicates a WUR type of the WUR, wherein the WUR type of the WUR is one of two or more defined WUR types each associated to one or more different sets of WUR related parameters, the WUR related parameters comprising: (i) radio frequency or intermediate frequency performance, (ii) selectivity, (iii) intermodulation rejection performance, (iv) sensitivity, or any combination of two or more of (i)-(iv);
information that indicates one or more parameters of the WUR, the one or more parameters of the WUR comprising a noise figure of the WUR, one or more filtering parameters of one or more filters of the WUR, and/or one or more clock impairments of the WUR;
information about an architecture of the WUR in terms of low-noise amplifier(s), analog-to-digital conversion, supported modulation scheme(s), and/or number of antennas;
information about one or more radio frequency capabilities of the WUR and/or information about one or more intermediate frequency capabilities of the WUR.

3-9. (canceled)

10. The method of claim 1, further comprising:
monitoring a serving cell signal level via a WUR, from among the one or more WURs, having reduced radio frequency and/or intermediate performance in terms of sensitivity, selectivity, and/or intermodulation rejection performance compared to that of the main receiver;
determining that the serving cell signal level is less than a predefined or configured threshold signal level; and
responsive to determining that the serving cell signal level is less than a predefined or configured threshold signal level, disabling the WUR.

11. The method of claim 10, further comprising, responsive to determining that the serving cell signal level is less than a predefined or configured threshold signal level, sending a message or indication to the network node that indicates that the WUR is out-of-coverage and therefore that the main receiver of the UE is used.

12. The method of claim 1, further comprising:
detecting a strength and/or quality of one or more signals via a WUR, from among the one or more WURs;
determining that the strength and/or quality of the one or more signals satisfy one or more requirements for triggering transmission of WUS to the UE; and
sending information or an indication to the network node that triggers enabling transmission of WUS to the UE.

13. The method of claim 1, further comprising:
monitoring a blocker or interferer signal level and/or a received power of one or more reference signals of the serving cell, using a WUR, from among the one or more WURs; and
determining whether to use the main receiver of the UE based on one or more results of the monitoring.

14. The method of claim 13, wherein:
determining whether to use the main receiver of the UE comprises determining to use the main receiver; and
the method further comprises:
waking up the main receiver; and
disabling the WUR.

15. The method of claim 14, further comprising sending a message or indication to the network node that indicates that the WUR is out of coverage and that the main receiver is used by the UE.

16. The method of claim 1, wherein the one or more WURs comprise two or more WURs, and the method further comprises switching between the two or more WURs in accordance with one or more rules.

17. The method of claim 1, wherein the one or more WURs comprise two or more WURs, and the method further comprises periodically switching between the two or more WURs.

18. The method of claim 1, further comprising:
measuring a reference signal received power (RSRP) value for a signal using a WUR from among the one or more WURs;
applying an offset to the RSRP value to provide an adjusted RSRP value; and
determining whether to activate the WUR and WUS transmission to the UE based on a comparison of the adjusted RSRP value and a threshold RSRP value.

19. The method of claim 1, further comprising:
measuring a reference signal received power (RSRP) value for a signal using a WUR from among the one or more WURs;
applying an offset to a threshold RSRP value to provide an adjusted threshold RSRP value; and
determining whether to the activate the WUR and WUS transmission to the UE based on a comparison of the RSRP value and the adjusted threshold RSRP value.

20. The method of claim 18, wherein the offset compensates for difference in sensitivity between the WUR and the main receiver of the UE.

21. (canceled)

22. The method of claim 1, further comprising performing one or more actions using the one or more WURs, wherein the one or more actions using the one or more WURs comprise:
measuring a signal strength or quality of one or more signals using a WUR;
determining whether to activate or deactivate the WUR based on the measured signal strength or quality of the one or more signals;
upon determining to activate the WUR, sending a message or indication to the network node to trigger activation of transmission of wake-up signals to the UE; and
upon determining to deactivate the WUR, deactivating the WUR with respect to monitoring for a WUS and sending a message or indication to the network node that indicates that the WUR has been deactivated and/or that the UE is using the main receiver rather than the WUR.

23-25. (canceled)

26. The method of claim 1, further comprising performing one or more actions using the one or more WURs, wherein the one or more WURs comprise two or more WURs, and the one or more actions comprise switching between the two or more WURs in accordance with one or more rules.

27. (canceled)

28. The method of claim 1, further comprising performing one or more actions using the one or more WURs, wherein the one or more actions using the one or more WURs comprise:
measuring a RSRP value for a signal using a WUR;
applying an offset to the RSRP value to provide an adjusted RSRP value;
determining whether to activate the WUR based on a comparison of the adjusted RSRP value and a threshold RSRP value.

29. The method of claim 1, further comprising performing one or more actions using the one or more WURs, wherein the one or more actions using the one or more WURs comprise:
measuring a RSRP value for a signal using a WUR;
applying an offset to a threshold RSRP value to provide an adjusted threshold RSRP value;
determining whether to the activate the WUR (e.g., and WUS transmission) based on a comparison of the RSRP value and the adjusted threshold RSRP value.

30-32. (canceled)

33. A User Equipment (UE) comprising:
a main receiver;
one or more wake-up receivers (WURs); and
processing circuitry associated with the main receiver and the one or more WURs, the processing circuitry configured to cause the UE to send, to a network node, information about the one or more WURs of the UE, wherein, for each WUR of the one or more WURs, the information indicates:
(a) whether the radio frequency or intermediate frequency performance of the WUR is reduced as compared to or the same as that of the main receiver;
(b) whether a selectivity of the WUR is reduced as compared to or the same as that of the main receiver;
(c) whether an intermodulation rejection performance of the WUR is reduced as compared to or the same as that of the main receiver;
(d) whether a sensitivity of the WUR is reduced as compared to or the same as that of the main receiver;
(e) information about an architecture of the WUR;
(f) a WUR type of the WUR;
(g) one or more parameters of the WUR;
(h) information about one or more radio frequency capabilities of the WUR and/or information about one or more intermediate frequency capabilities of the WUR; or
(i) any combination of two or more of (a)-(h).

34-45. (canceled)

46. A method performed by a network node, the method comprising:
receiving, from a User Equipment (UE), information about one or more wake-up receivers (WURs) of the UE, wherein the UE is equipped with the one or more WURs and a main receiver, and, for each WUR of the one or more WURs, the information indicates:
(a) whether the radio frequency or intermediate frequency performance of the WUR is reduced as compared to or the same as that of the main receiver;
(b) whether a selectivity of the WUR is reduced as compared to or the same as that of the main receiver;
(c) whether an intermodulation rejection performance of the WUR is reduced as compared to or the same as that of the main receiver;
(d) whether a sensitivity of the WUR is reduced as compared to or the same as that of the main receiver;
(e) information about an architecture of the WUR;
(f) a WUR type of the WUR;
(g) one or more parameters of the WUR;
(h) information about one or more radio frequency capabilities of the WUR and/or information about one or more intermediate frequency capabilities of the WUR; or
(i) any combination of two or more of (a)-(h).

47-61. (canceled)

62. A network node comprising processing circuitry configured to cause the network node to:
receive, from a User Equipment (UE), information about one or more wake-up receivers (WURs) of the UE, wherein the UE is equipped with the one or more WURs and a main receiver, and, for each WUR of the one or more WURs, the information indicates:
(a) whether the radio frequency or intermediate frequency performance of the WUR is reduced as compared to or the same as that of the main receiver;
(b) whether a selectivity of the WUR is reduced as compared to or the same as that of the main receiver;
(c) whether an intermodulation rejection performance of the WUR is reduced as compared to or the same as that of the main receiver;
(d) whether a sensitivity of the WUR is reduced as compared to or the same as that of the main receiver;
(e) information about an architecture of the WUR;
(f) a WUR type of the WUR;
(g) one or more parameters of the WUR;
(h) information about one or more radio frequency capabilities of the WUR and/or information about one or more intermediate frequency capabilities of the WUR; or
(i) any combination of two or more of (a)-(h).

63. (canceled)
